(19) United States
(12) Patent Application Publication
(10) Pub. No.: US 2009/0291695 A1
(43) Pub. Date: Nov. 26, 2009

(54) METHOD AND SYSTEM FOR PAGING MOBILE DEVICES IN A WIRELESS NETWORK

(75) Inventors: Mark Alan Lipford, Leawood, KS (US); Karen D. Thompson, Overland Park, KS (US); Chunmei Liu, Great Falls, VA (US); Ojas T. Choksi, Herndon, VA (US)

Correspondence Address: Setter Roche LLP, P.O. Box 780, Erie, CO, 80516, US

(73) Assignee: Clear Wireless LLC, Kirkland, WA (US)

(21) Appl. No.: 12/464,208

(22) Filed: May 12, 2009

Related U.S. Application Data
(60) Provisional application No. 61/054,847, filed on May 21, 2008.

(51) Int. Cl. H04W 68/00

(52) U.S. Cl. 455/458

(57) ABSTRACT

A paging initiation message is received at a first node transferred from the communication network. A paging announce message is generated at the first node based upon a last known location for the mobile station. The paging announce message comprises one or more identifiers associated with a proximate location of the mobile station. The paging announce message is sent to one or more paging groups. Each of the paging groups comprise one or more network elements associated with the one or more identifiers. A mobile paging message is generated at the one or more network elements when the one or more network elements comprise one or more network subelements identified by the one or more identifiers. The mobile paging message is sent to the mobile station transferred from the one or more network subelements.

### REFERENCE

This patent application claims the benefit of U.S. provisional patent application 61/054,847; entitled METHOD AND SYSTEM FOR PAGING MOBILE DEVICES IN A WIRELESS NETWORK; filed on May 21, 2008; and hereby incorporated reference into this patent application.

### TECHNICAL BACKGROUND

Wireless communication may be used as a means of accessing a network. Wireless communication has certain advantages over wired communications for accessing a network. One of those advantages is a lower cost of infrastructure to provide access to many separate locations or addresses compared to wired communications. This is the so-called “last mile” problem. Another advantage is mobility. Wireless communication devices, such as cell phones, are not tied by wires to a fixed location. To use wireless communication to access a network, a customer needs to have at least one transceiver in active communication with another transceiver that is connected to the network.

To facilitate wireless communications, the Institute of Electrical and Electronics Engineers (IEEE) has promulgated a number of wireless standards. These include the 802.11 (WiFi) standards and the 802.16 (WiMAX) standards. Likewise, the International Telecommunication Union (ITU) has promulgated standards to facilitate wireless communications. This includes TIA-856, which is also known as Evolution-Data Optimized (EV-DO). The European Telecommunications Standards Institute (ETSI) has also promulgated a standard known as long term evolution (LTE). Additional standards such as the fourth generation communication system (4G) are also being pursued. These standards pursue the aim of providing a comprehensive IP solution where voice, data, and streamed multimedia can be given to users on an “anytime, anywhere” basis. These standards also aim to provide higher data rates than previous generations. All of these standards may include specifications for various aspects of wireless communication with a network. These aspects include processes for registering on the network, carrier modulation, frequency bands of operation, and message formats.

### OVERVIEW

A method for paging a mobile station in a communication network is disclosed. A paging initiation message is received at a first node transferred from the communication network. A paging announce message is generated at the first node based upon a last known location for the mobile station. The paging announce message comprises one or more identifiers associated with a proximate location of the mobile station. The paging announce message is sent to one or more paging groups. Each of the paging groups comprise one or more network elements associated with the one or more identifiers. A mobile paging message is generated at the one or more network elements when the one or more network elements comprise one or more network subelements identified by the one or more identifiers. The mobile paging message is sent to the mobile station transferred from the one or more network subelements.

A method for paging a mobile station in a communication network is further disclosed. Mobile station data is received at a first node transferred from a mobile network internet node. A paging initiation message is received at a paging control node transferred from the first node. A paging announce message is generated at the paging control node based upon a last known location for the mobile station. The paging announce message comprises one or more identifiers associated with network subelements in proximity to a location of the mobile station. The paging announce message is sent to one or more paging elements associated with one or more network elements. Each of the one or more network elements comprises the one or more network subelements in proximity to the location of the mobile station. A mobile paging message is generated at the one or more paging elements. The mobile paging message is sent to the mobile station transferred from the one or more network subelements.

A method for paging a mobile station in a communication network is further disclosed. A location update request for a mobile station is received at a first node. A paging initiation message is received at a second node transferred from the first node. A paging announce message is generated at the second node based upon a last known location for the mobile station. The paging announce message comprises one or more identifiers for one or more network subelements in proximity to a location of the mobile station. The paging announce message is sent to one or more paging elements associated with one or more network elements. Each of the one or more network elements comprises the one or more network subelements in proximity to the location of the mobile station. A mobile paging message is generated at the one or more paging elements. The mobile paging message is sent to the mobile station transferred from the one or more network subelements.

### BRIEF DESCRIPTION OF THE DRAWINGS

FIG. 1 is a block diagram illustrating an exemplary embodiment for paging a wireless device.

FIG. 2 illustrates a flow diagram for utilizing a method for paging a mobile device in a wireless communication network.

FIG. 3 illustrates a WiMAX paging network model.

FIG. 4 illustrates a paging network model.

FIG. 5 is a block diagram illustrating a computing system.

### DETAILED DESCRIPTION

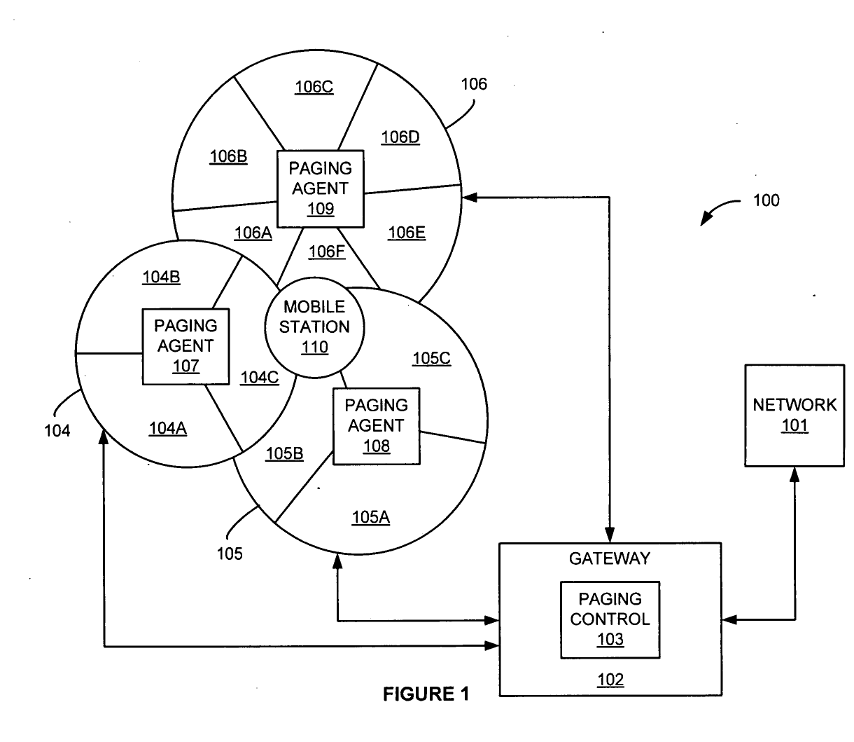

FIG. 1 is a block diagram illustrating an exemplary embodiment for paging a wireless device. FIG. 1 comprises communication network 100, network 101, gateway 102, paging control 103, base station 104, base station 105, base station 106, paging agent 107, paging agent 108, paging agent 109 and mobile station 110.

Base station 104 comprises sector 104A, sector 104B and sector 104C. Base station 105 comprises sector 105A, sector 105B and sector 105C. Base station 106 comprises sector 106A, sector 106B, sector 106C, sector 106D, sector 106E and sector 106F. Paging control 103 is shown as part of gateway 102. One skilled in the art would understand that paging control 103 could be a separate network element outside of gateway 102 or integrated with gateway 102.

Gateway 102 exchanges information with base stations 104-106 and with network 101. Also, mobile station 110 may exchange information over a wireless link with base station 104, base station 105 and base station 106. Paging agents 107-109 exchange information with paging controller 103. Thus, network 101 may exchange information with mobile station 110 utilizing the network elements described above.

Communication network 100 may comprise any wireless network that provides communication connectivity for mobile station 110 to communicate with other users. Wireless network protocols that may be utilized by communication network 100 may include code division multiple access (CDMA) 1×RTT, Global System for Mobile communications (GSM), Universal Mobile Telecommunications System (UMTS), High-Speed Packet Access (HSPA), Evolution-Data Optimized (EV-DO), EV-DO rev. A, Third Generation Partnership Project Long Term Evolution (3GPP LTE), Worldwide Interoperability for Microwave Access (WiMAX) and the like.

Network 101 includes multiple network elements to facilitate communication between gateways and other communication networks. Network 101 may include elements that perform network management functions. Examples of network management functions comprise controlling, planning, allocating, deploying, coordinating, and monitoring the resources of a network, including performing functions such as initial network planning, frequency allocation, predetermined traffic routing to support load balancing, cryptographic key distribution authorization, configuration management, fault management, security management, performance management, bandwidth management, and accounting management. Elements that may perform management functions comprise authentication servers, provisioning servers, security servers, billing platforms and any other platform that enables a network provider to manage its network. Network 101 may also maintain subscriber information associated with users that have permission to utilize communication network 100.

Network 101 may also utilize other network elements to provide data connectivity to other networks. Examples of these network elements comprise networking routers such as home agents (HAs) and foreign agents (FAs).

Gateway 102 provides communication connectivity and acts as an aggregator of traffic or interworking device between one or more base stations or base station controllers (not shown) and network 101. Examples of gateway 102 may include an access service network gateway (ASN-GW), wireless local access network access gateway (WAG), packet data gateway (PDG), mobile switching center (MSC) and packet data serving node (PDSN).

Base stations 104-106 may be any wireless system that provides the air interface to mobile stations and communication connectivity to the communication network. Examples of base stations that may be utilized include base station transceivers (BTSs), base station controllers (BSCs), base station (BSs), radio base stations (RBSs), Node B, enhanced Node B (eNBs) and others. Base stations 104-106 may include a number of elements known to those skilled in the art comprising a transceiver, power amplifier, combiner, duplexer, antenna and control function. Further, base stations 104-106 may comprise one antenna or multiple antennas having corresponding sectors and frequency assignments. Base stations 104-106 may have several transceivers and corresponding antennas which allow it to serve several different frequencies and different sectors of the base station.

Base stations 104-106 are illustrated as being subdivided to a number of fields or sectors where each may be illuminated from an antenna directive or panel (not shown), that is an antenna that does not illuminate in all the directions, but instead concentrates the energy within a particular sector. Base stations that do not have sectors may be characterized by having omni-directional or unidirectional antennas that radiate energy in all directions.

Referring to FIG. 1, base station 104 is shown having three sectors—sectors 104A-104C. Likewise, base station 105 is shown having three sectors—sectors 105A-105C. Further, base station 106 is shown having six sectors—sectors 106A, 106B, 106C, 106D, 106E and 106F. Sectors 104A-104C, 105A-105C and 106A-106F provide wireless access in particular areas for their respective base stations.

Paging may be referred to as a broadcast mechanism in mobile communication networks. Broadcast mechanisms are used to distribute information to multiple mobiles stations. Paging may be used to set up communication channels between mobile stations and base stations.

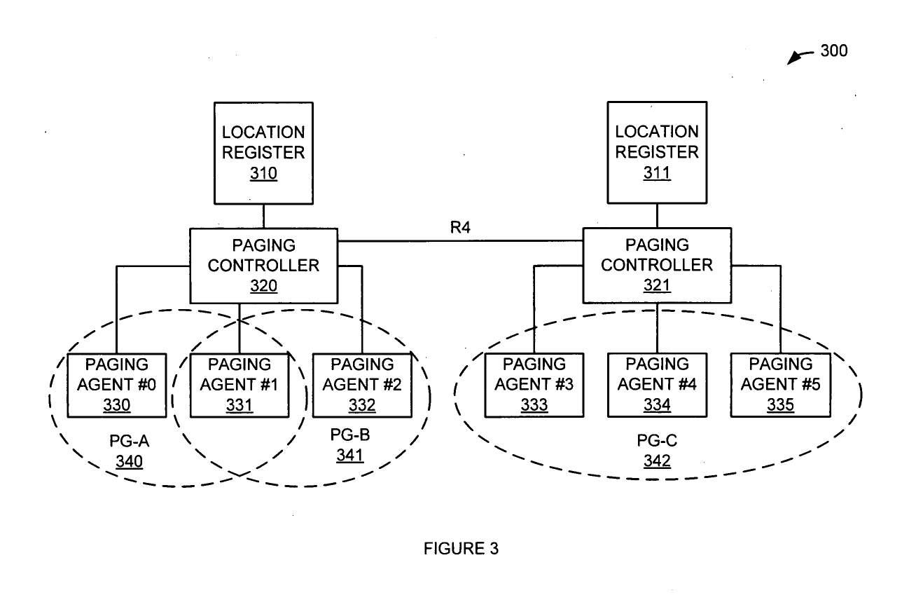

In some wireless communication technologies, paging is utilized to alert mobile stations that are in idle mode about an incoming message or request from a base station. Idle mode is a process for mobile stations to receive information from a base station without having to be registered on the communication network. In one example, a WiMAX paging network model is shown in FIG. 3.

As shown in FIG. 3, paging reference model 300 comprises: location register 310, location register 311, paging controller 320, paging controller 321, paging agent 330, paging agent 331, paging agent 332, paging agent 333, paging agent 334, and paging agent 335. Location register 310 is operatively coupled to paging controller 320. Paging controller 320 is operatively coupled to paging agents 330-332. Location register 311 is operatively coupled to paging controller 321. Paging controller 321 is operatively coupled to paging agents 333-335. Paging controller 320 is also operatively coupled to paging controller 321 via an R4 link.

The WiMAX paging reference model, as shown in FIG. 3, includes three separate functional entities: paging agents 330-335, paging controllers 320-321, and location registers 310-311. Paging controllers 320-321 administer the activity of idle-mode mobile stations in the network. Paging controllers 320-321 are identified in the WiMAX specification by PC ID which is six bytes long. Paging controllers 320-321 may be co-located with a base station. Paging controllers 320-321 may be separate from a base station and linked by R6 reference point. For each, idle-mode mobile station, WiMAX requires a single paging controller 320-321 that contains location information about the mobile station. This paging controller 320-321 is referred to as the anchor paging controller 320-321. Additional paging controllers 320-321 may relay paging and location management messages between paging agents 330-335 and the anchor paging controller 320-321. These additional paging controllers 320-321 are called relay paging controllers. Paging agents 330-335 are entities that handle the interaction between the paging controllers 320-321 and the WiMAX specified paging related functions. Paging agents 330-335 may reside within a base station.

Multiple paging agents 330-335 can be aggregated to form paging groups 340-342. For example, in FIG. 3, paging agent 330 and paging agent 331 form paging group A (PG-A) 340. Paging agent 331 and paging agent 332 form paging group B (PG-B) 341. Paging agents 333-335 form paging group C (PG-C) 342. A paging group 340-342 resides within a network access point boundary and is provisioned and managed by the network operator. A paging agent may belong to more than one paging group. For example, in FIG. 3, this is shown by paging agent 331 which belongs to both paging group A 340 and paging group B 341.

Location registers 310-311 maintain and track information about idle mobile stations. Location registers 310-311 may comprise a distributed database. For each idle-mode mobile station, the information contained in the location register 310-311 includes its current paging group ID, paging cycle, paging offset, and service flow information. An instance of location register 310-311 is associated with every anchor paging controller 320-311. When a mobile station moves across paging groups its location is updated across paging controllers 320-321 via R6 and/or R4 reference points. The information in the location register 310-311 associated with the anchor paging controller 320-321 assigned to the mobile station is also updated.

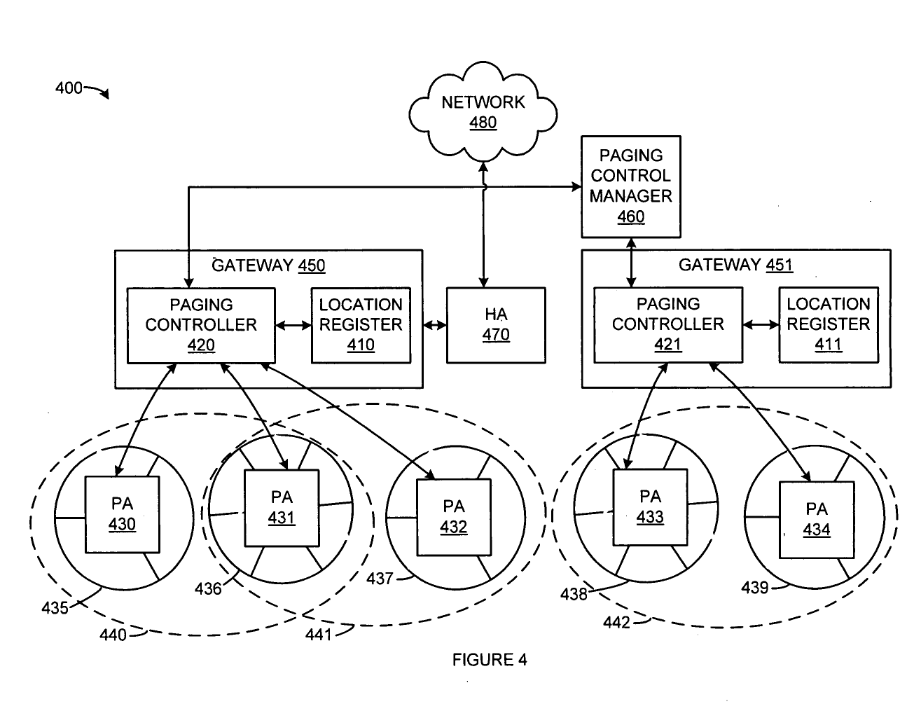

In another example, a paging network model is shown in FIG. 4. In FIG. 4, paging network 400 comprises: paging agent 430-434, sectors 435-439, gateway 450, gateway 451, paging control manager 460, home agent (HA) 470, and network 480. Sectors 435 are associated with paging agent 430. Sectors 436 are associated with paging agent 431. Sectors 437 are associated with paging agent 432. Sectors 438 are associated with paging agent 433. Sectors 439 are associated with paging agent 434.

Gateway 450 includes paging controller 420 and location register 410. Paging controller 420 is operatively coupled to location register 410. Paging controller 420 is operatively coupled paging control manager 460. Gateway 451 includes paging controller 421 and location register 411. Paging controller 421 is operatively coupled to location register 411. Paging controller 421 is operatively coupled paging control manager 460. Gateway 450 to operatively coupled to home agent 470. Home agent 470 is operatively coupled to network 480. Paging controller 420 is operatively coupled to paging agents 430-432. Paging controller 421 is operatively coupled to paging agents 433-434.

Paging agents 430 and 431 are part of paging group 440. Paging agents 431 and 432 are part of paging group 441. Paging agents 433 and 434 are part of paging group 442.

Referring back to FIG. 1, paging controller 103 provides administration and control for paging functions for communication network 100. Paging controller 103 may comprise any functional or logical entity or element that may be located at a base station or gateway. FIG. 1 illustrates paging controller 103 residing at gateway 102 but it would be known to have paging controller functionality distributed among several network elements. It should be understood that more than one paging controller may be necessary to provide paging functionality to mobile station 110.

Paging agents 107-109 provide the interaction functionality between paging controllers and mobile stations. Paging agents 107-109 may comprise any functional or logical entity or element that may be located at a base station or any other network element to facilitate communication with mobile station 110. FIG. 1 illustrates paging agents 107-109 residing at base stations 104-106 respectively.

Mobile station 110 may be any device that has wireless communication connectivity that may be readily moved from one location to another. Mobile station 101 could include telephones, smartphones, mobile phones, cellular phones, personal digital assistants (PDAs), personal communicators, handheld game consoles, personal computers (PCs), Ultra-Mobile personal computers (UMPCs), handheld televisions and any other consumer appliance with wireless communication capabilities.

In operation, paging is performed by wireless communication networks to establish communication with idle mobile stations. Groups of base stations and paging agents may be assigned to a paging group. Paging groups may include base stations that are associated with different gateways. As such, while FIG. 1 shows only one gateway and paging controller, multiple gateways with their associated paging controllers may be necessary to perform a paging function. Likewise, multiple paging controllers and associated location registers, as shown in FIG. 3 and FIG. 4, are possible.

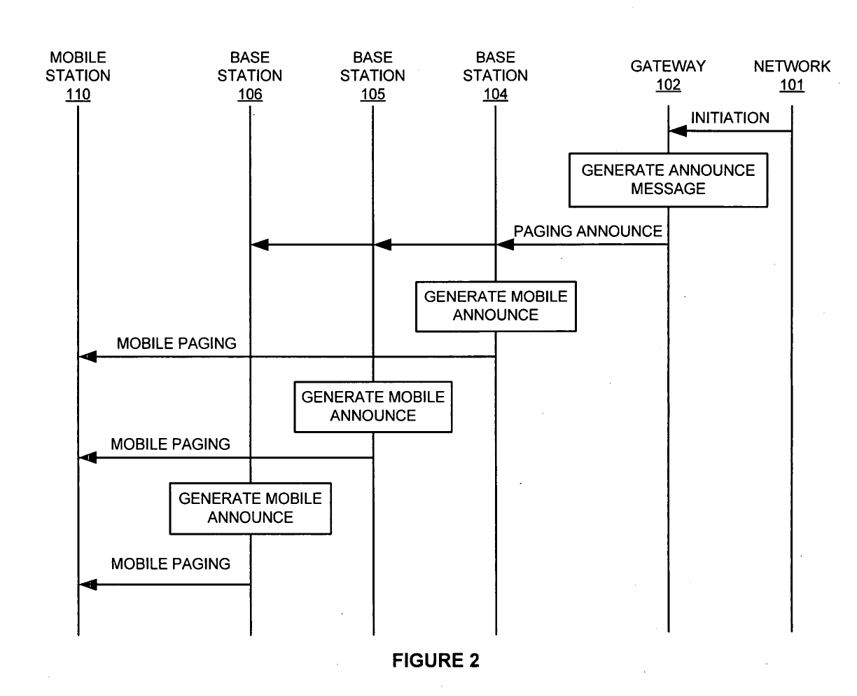

FIG. 2 illustrates a flow diagram for utilizing a method for paging a mobile device in a wireless communication network. A paging initiation message is received at gateway 102 transferred from network 101. Paging initiation may be triggered when network 101 needs to establish communication with mobile station 110. Communication establishment may be needed for delivering incoming data or phone call from network 101 to mobile station 110. Also, communication establishment may be needed to update the location of mobile station 110 within a communication network. Other reasons for network 101 to establish communication with mobile station 110 would be known by those skilled in the art.

A paging announce message is created at gateway 102. The paging announce message is created utilizing the location of mobile station 110. Location registers may be utilized for storing mobile station location data for use by paging controller 103. The paging announce message comprises the identifiers for the one or more sectors that are in proximity to location of mobile station 110. For example, referring to FIG. 1, mobile station 110 is shown as being in proximity to base station 104's sector 104C, base station 105's sectors 105B and 105C and base station 106's sector 106F. The size of the area that defines the proximity of mobile station 110 to the shown base stations and their sectors may be increased or decreased depending upon the particular implementation.

The paging announce message is sent to base stations 104-106. The paging announce message may be sent as a single message broadcast to all of the base stations or may be sent as individual messages sent to each base station independently. In one example, the paging announce message is only sent to those base stations that have sectors identified in the paging announce message. In another example, the paging announce message may be sent to all of the base stations in the paging group. The paging announcement may also be sent to a paging group comprising one or more base stations. If so, the paging announce message may be sent to all of the base stations in the paging group or to only the base stations having sectors in proximity to the mobile station.

Table 1 gives an example R6 paging announce message. Table 1 may be used as a substitute or alternative paging announce message to that given in Table 4-134 of the WiMAX Forum Network Architecture (Stage 3: Detailed Protocols and Procedures), Release 1, Version 1.2.2, May 10, 2008. The WiMAX Forum Network Architecture (Stage 3: Detailed Protocols and Procedures), Release 1, Version 1.2.2, May 10, 2008 is hereby incorporated herein by reference.

TABLE 1

| IE | Reference | M/O | Notes |
|---|---|---|---|
| Failure Indication | 5.3.2.69 | O | |
| BS Info(s) | | O | One or more. This SHALL be included if a cell site has one |
| | | | or more sectors or frequency allocations. All BSID associated |
| | | | with different sectors and frequencies SHALL be included in |
| | | | a single Paging Announce message over R6. |
| >BS ID | | O | |
| MS Info | | M | |
| >MS ID | | M | |
| >SF Info | 5.3.2.185 | O | SF Flow Info for preferential treatment for paging and call |
| | | | origination |
| | | | This is not included for paging stop operation. |
| >Authenticator ID | 5.3.2.19 | O | Included if received in the R4 Paging_Announce message |
| Paging Information | 5.3.2.119 | O | This compound TLV contains Paging Cycle, Paging Offset, |
| | | | PAGING_INTERVAL_LENGTH and PG ID. |
| | | | This IE is included for Paging (start) operation; however it is |
| | | | not required for Paging stop |
| >PCID | 5.3.2.119 | O | Used for topologically unaware paging |
| | | | This is not included for paging stop operation. |
| >Anchor PC ID | 5.3.2.12 | O | Included if received in the R4 Paging_Announce message. |
| >Paging Start/Stop | 5.3.2.184 | M | |
| >Paging Announce | 5.3.2.115 | O | This IE is included for Paging (start) operation. |
| Timer | | | This is not included for paging stop operation. |
| >Paging Cause | 5.3.2.116 | O | 01 = Location update |
| | | | 02 = Network Re-Entry, Incoming Data for Idle MS |
| | | | Other values are reserved |

A mobile paging message is generated at base stations 104-106. The mobile paging message is created based upon the paging announce message and in particular, the sectors identified in the paging announce message.

The mobile paging message is sent to mobile station 110 by those sectors identified in the paging announce message. For example, referring to FIG. 1, the mobile paging message would be sent to by base stations 104-106 utilizing sectors 104C, 105B, 105C and 106F.

A method for paging a mobile station in a communication network comprises: receiving a paging initiation message at a gateway node transferred from the communication network; generating a paging announce message at the gateway node based upon a last known location for the mobile station, wherein the paging announce message comprises one or more sector identifiers for one or more sectors in proximity to a location of the mobile station; sending the paging announce message to one or more paging groups, wherein each of the paging groups comprise one or more base stations and wherein each of the one or more base stations comprise the one or more sectors; generating a mobile paging message at the one or more base stations when the one or more base stations comprise the one or more sectors identified by the one or more sector identifiers; and, sending the mobile paging message to the mobile station transferred from the one or more sectors.

A method for paging a mobile station in a communication network comprises: receiving a paging initiation message at a gateway node transferred from the communication network; generating a paging announce message at the gateway node based upon a last known location for the mobile station, wherein the paging announce message comprises one or more sector identifiers for one or more sectors in proximity to a location of the mobile station; sending the paging announce message to one or more base stations, wherein each of the one or more base stations comprise the one or more sectors in proximity to the location of the mobile station; generating a mobile paging message at the one or more base stations; and sending the mobile paging message to the mobile station transferred from the one or more sectors.

A method for paging a mobile station in a communication network comprises: receiving a paging initiation message at a paging control node transferred from the communication network; generating a paging announce message at the paging control node based upon a last known location for the mobile station, wherein the paging announce message comprises one or more sector identifiers for one or more sectors in proximity to a location of the mobile station; sending the paging announce message to one or more paging groups, wherein each of the paging groups comprise one or more paging agents associated with one or more base stations and wherein each of the one or more base stations comprise the one or more sectors; generating a mobile paging message at the one or more paging agents when the one or more base stations comprise the one or more sectors identified by the one or more sector identifiers; and, sending the mobile paging message to the mobile station transferred from the one or more sectors.

A method for paging a mobile station in a communication network comprises: receiving a paging initiation message at a paging control node transferred from the communication network; generating a paging announce message at the paging control node based upon a last known location for the mobile station, wherein the paging announce message comprises one or more sector identifiers for one or more sectors in proximity to a location of the mobile station; sending the paging announce message to one or more paging agents associated with one or more base stations, wherein each of the one or more base stations comprise the one or more sectors in proximity to the location of the mobile station; generating a mobile paging message at the one or more paging agents; and, sending the mobile paging message to the mobile station transferred from the one or more sectors.

A method for paging a mobile station in a communication network comprises: receiving mobile station data at a gateway node transferred from a mobile network internet node; receiving a paging initiation message at a paging control node transferred from the gateway node; generating a paging announce message at the paging control node based upon a last known location for the mobile station, wherein the paging announce message comprises one or more sector identifiers for one or more sectors in proximity to a location of the mobile station; sending the paging announce message to one or more paging agents associated with one or more base stations, wherein each of the one or more base stations comprise the one or more sectors in proximity to the location of the mobile station; generating a mobile paging message at the one or more paging agents; and, sending the mobile paging message to the mobile station transferred from the one or more sectors.

A method for paging a mobile station in a communication network comprises: receiving a location update request for a mobile station at a gateway node; receiving a paging initiation message at a paging control node transferred from the gateway node; generating a paging announce message at the paging control node based upon a last known location for the mobile station, wherein the paging announce message comprises one or more sector identifiers for one or more sectors in proximity to a location of the mobile station; sending the paging announce message to one or more paging agents associated with one or more base stations, wherein each of the one or more base stations comprise the one or more sectors in proximity to the location of the mobile station; generating a mobile paging message at the one or more paging agents; and, sending the mobile paging message to the mobile station transferred from the one or more sectors.

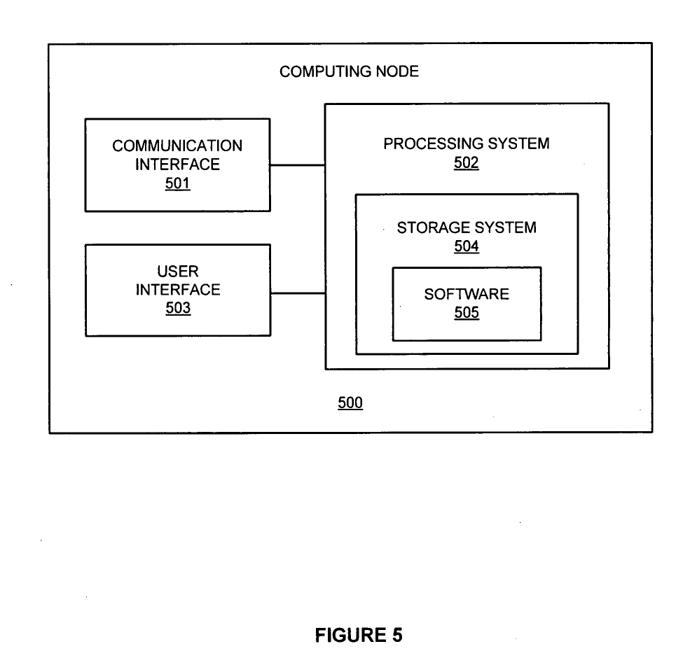

FIG. 5 is a block diagram illustrating a computing system that may be utilized by the network elements described in FIGS. 1-4 and for the methods described herein. Computing node 500 includes communication interface 501, processing system 502, and user interface 503. Processing system 502 includes storage system 504.

Storage system 504 stores software 505. Processing system 502 is linked to communication interface 501 and user interface 503. Computing node 500 could be comprised of a programmed general-purpose computer, although those skilled in the art will appreciate that programmable or special purpose circuitry and equipment may be used. Computing node 500 may be distributed among multiples devices that together comprise elements 500-505.

Communication interface 501 could comprise a network interface, modem, port, transceiver, or some other communication device. Communication interface 501 may be distributed among multiple communication devices. Processing system 502 could comprise a computer microprocessor, logic circuit, or some other processing device. Processing system 502 may be distributed among multiple processing devices. User interface 503 could comprise a keyboard, mouse, voice recognition interface, microphone and speakers, graphical display, touch screen, or some other type of user device. User interface 503 may be distributed among multiple user devices. Storage system 504 could comprise a disk, tape, integrated circuit, server, or some other memory device. Storage system 504 may be distributed among multiple memory devices.

Processing system 502 retrieves and executes software 505 from storage system 504. Software 505 may comprise an operating system, utilities, drivers, networking software, and other software typically loaded onto a computer system. Software 505 could comprise an application program, firmware, or some other form of machine-readable processing instructions. When executed by processing system 502, software 505 directs processing system 502 to operate as described herein.

What is claimed is:

1. A method for paging a mobile station in a communication network, the method comprising:
receiving a paging initiation message at a first node transferred from the communication network;
generating a paging announce message at the first node based upon a last known location for the mobile station, wherein the paging announce message comprises one or more identifiers associated with a proximate location of the mobile station;
sending the paging announce message to one or more paging groups, wherein each of the paging groups comprise one or more network elements associated with the one or more identifiers;
generating a mobile paging message at the one or more network elements when the one or more network elements comprise one or more network subelements identified by the one or more identifiers; and,
sending the mobile paging message to the mobile station transferred from the one or more network subelements.

2. The method of claim 1, wherein the first node is a paging control node.

3. The method of claim 1, wherein the first node is a gateway node.

4. The method of claim 1, wherein the one or more network elements comprise a base station.

5. The method of claim 1, wherein the one or more network elements comprise a paging agent associated with one or more base stations.

6. The method of claim 1, wherein the one or more network subelements are sectors.

7. The method of claim 1, wherein the identifiers associated with a proximate location of the mobile station are sector identifiers.

8. The method of claim 1, wherein the one or more network elements are base stations, the one or more network subelements are sectors, and the identifiers associated with a proximate location of the mobile station are sector identifiers.

9. A method for paging a mobile station in a communication network, the method comprising:
receiving mobile station data at a first node transferred from a mobile network internet node;
receiving a paging initiation message at a paging control node transferred from the first node;
generating a paging announce message at the paging control node based upon a last known location for the mobile station, wherein the paging announce message comprises one or more identifiers associated with network subelements in proximity to a location of the mobile station;
sending the paging announce message to one or more paging elements associated with one or more network elements, wherein each of the one or more network elements comprise the one or more network subelements in proximity to the location of the mobile station;
generating a mobile paging message at the one or more paging elements; and,
sending the mobile paging message to the mobile station transferred from the one or more network subelements.

10. The method of claim 9, wherein the first node is a paging control node.

11. The method of claim 9, wherein the first node is a gateway node.

12. The method of claim 9, wherein the one or more network elements comprise a base station.

13. The method of claim 9, wherein the one or more paging elements comprise paging groups.

14. The method of claim 9, wherein the one or more paging elements comprise paging agents.

15. The method of claim 9, wherein the one or more network elements are base stations and the network subelements are sectors.

16. A method for paging a mobile station in a communication network, the method comprising:
receiving a location update request for a mobile station at a first node;
receiving a paging initiation message at a second node transferred from the first node;
generating a paging announce message at the second node based upon a last known location for the mobile station, wherein the paging announce message comprises one or more identifiers for one or more network subelements in proximity to a location of the mobile station;
sending the paging announce message to one or more paging elements associated with one or more network elements, wherein each of the one or more network elements comprise the one or more network subelements in proximity to the location of the mobile station;
generating a mobile paging message at the one or more paging elements; and,
sending the mobile paging message to the mobile station transferred from the one or more network subelements.

17. The method of claim 16, wherein the first node is a gateway node.

18. The method of claim 16, wherein the second node is a paging control node.

19. The method of claim 16, wherein the one or more paging elements are paging agents.

20. The method of claim 16, wherein the first node is a gateway node, the second node is a paging control node, the one or more network elements comprise a base station, and the one or more network subelements comprise a sector.
